(19) United States
(12) Patent Application Publication
(10) Pub. No.: US 2016/0056601 A1
(43) Pub. Date: Feb. 25, 2016

(54) BRUSH STRUCTURE OF FUEL PUMP FOR VEHICLE

(71) Applicant: HYUNDAM INDUSTRIAL CO., LTD, Chungcheongnam-do (KR)

(72) Inventors: Jun Yeong LEE, Busan (KR); Yong Jun JEON, Chungcheongnam-do (KR)

(73) Assignee: HYUNDAM INDUSTRIAL CO., LTD, Chungcheongnam-do (KR)

(21) Appl. No.: 14/720,019

(22) Filed: May 22, 2015

(30) Foreign Application Priority Data
Aug. 22, 2014 (KR) 10-2014-0109509

(51) Int. Cl. H01R 39/02

(52) U.S. Cl. CPC H01R 39/025

(57) ABSTRACT

There is provided structure of a brush of a fuel pump for a vehicle in which the brush is formed of two kinds of different materials unlike a typical brush which is formed of only one material, more particularly, a high resistance material is used at one side portion only of the brush, and the same efficiency is ensured as that of the typical brush formed of low resistance material only, by suppressing the spark generation even in use of ethanol and low grade fuels and suppressing the spark generated in high current fuel pump and minimizing the abrasion of the structure due to decrease of spark generation, thereby ensuring the durability and the reliability and improving the EMI characters due to decrease of spark noise of the fuel pump.

### TECHNICAL FIELD

The present invention relates to the structure of a brush of a fuel pump for vehicle, and more particularly, to the structure of a brush of a fuel pump for vehicle, which is composed of two kinds of different materials to suppress the spark generation caused upon the brushes taken off at a plurality of commutator slots when an armature is rotated.

### BACKGROUND ART

Among fuel pumps for vehicles, electromagnetic-operating fuel pump device is composed of an electric motor and a pump driven by the motor. The motor provides the path for electric source by the contact of a brush and a commutator. The armature formed with coils wound with electric source supplied is rotated by electromagnetic-influenced impact. The motor rotated by electromagnetic force adsorbs fuel by the rotation of an impeller connected by the same shaft so as to supply to internal combustion engine of a vehicle.

The brush of the fuel pump is a main factor determining the life time of the fuel pump.

A conductivity of domestic car fuel (gasoline) is 1 uS/m, and is conductive little fluid. Even single brush being used these days is in the state to sufficiently satisfy the endurance and reliability.

However, the driving environment of a fuel pump becomes worse by the physical property changes of the fuel such as conductivity increase when foreign materials (moisture, salinity, ethanol, and so on) exist in the fuel, which fatally damages on the brush and the commutator which transfer electricity.

The international fuel standards are allowing the mixing of ethanol these days (US E20), and so the usage environment of fuel pumps driven by the fuel becomes worse electrically. In Brazil, reliability of E100 in driving environment is required.

When spark occurs in such unfavorable environment, and thereby the intensity of the spark generated and the spark generation amount exceed a certain level of limitation, it causes abnormal abrasion on the brush and the commutator, and brings the problems of failures in car starting and accelerating.

The frequency and the intensity of the spark generation in the driving environment of normal fuel pump (the use of gasoline and diesel) guarantee the sufficiently stable reliability even in the structure of existing brushes.

However, the sparks generation frequency and the intensity from advanced specification (high current) in existing vehicles systems according to the demands of fuel pressure increase and oil discharging increase, and from fuels components including ethanol and low grade materials have reached the levels exceeding several to dozens of times those of normal degrees.

When up to these levels, a brush reaches its limitation and finally occurs working failures of fuel pumps and accelerating failures thereof due to damages of brush and commutator.

### DISCLOSURE

### Technical Problem

Therefore, the present invention has been made to solve the above problems, and it is an aspect of the present invention to provide the structure of a brush for vehicle fuel pump by applying a high resistance material to one side portion only of the brush thereby ensuring endurance durability by suppressing the spark generation by use of ethanol and low fuels and minimizing the spark generation, and minimizing abrasion amount by relatively suppressing the spark generation occurred in high current fuel pump, and improving EMI characters by decreasing spark noise of fuel pump, and providing the same efficiency as that in the use of typical brush formed of low resistance material.

Other objects and advantages of the invention will become apparent from embodiments of the invention to be described later. The objects and advantages of the invention can be embodied by means described in the appended claims and combinations thereof.

### Technical Solution

In accordance with the present invention, the above and other aspects can be accomplished by providing a structure of a brush of a fuel pump for a vehicle configured such that a plurality of brushes are in contact with commutators divided into a plurality of segments in an armature of a fuel pump for a vehicle, wherein the brush is formed of two kinds of different materials and relatively high resistance material is used on one side portion only of the brush in order to suppress the spark generation when the brush contacts to the lines between a plurality of commutator segments at the rotation of the armature thereby to decrease the amount of spark and the generation frequency thereof which is occurred when the brush is detached at the slots of the commutator in the typical brush which is formed of one kind low resistance material only.

### Advantageous Effects

As described above, in accordance with the present invention, high reliability of a fuel pump for vehicle is secured even in various kinds of fuels by using a high resistance material in one side portion only of the brush thereby providing the same efficiency as that in the use of typical brush formed of low resistance material, increasing the endurance and reliability by suppressing the spark generation by use of ethanol and low grade fuels, minimizing the spark generation, and minimizing abrasion amount by relatively suppressing the spark generation occurred in high current fuel pump, and improving EMI characters by decreasing spark noise of fuel pump.

### DESCRIPTION OF DRAWINGS

These and other aspects and advantages of the present invention will become apparent and more readily appreciated from the following description of the embodiments, taken in conjunction with the accompanying drawings, in which:

FIG. 1 is a sectional view of a fuel pump of a vehicle according to one embodiment of the present invention;

FIG. 2 is a plan view of a brush and a commutator according to one embodiment of the present invention;

FIG. 3 is a perspective view of a brush according to one embodiment of the present invention; and

FIG. 4 is graphical views showing spark amounts measured in a brush of the present invention and a typical brush.

[Brief description of reference numbers of major elements]

| | |
|---|---|
| 1: fuel pump | 2: armature |
| 3: commutator | 4: brush |

### BEST MODE

The present invention to achieve the above aspects has the characteristics as follows:

In accordance with an embodiment of the present invention, there is provided a structure of a brush of a fuel pump for a vehicle configured such that a plurality of brushes are in contact with commutators divided into a plurality of segments in an armature of a fuel pump for a vehicle, in which the brush is formed of two kinds of materials to suppress the spark generation caused when the brush is detached at the slot of the commutator at the rotation of the armature.

### Mode for Invention

The present invention will now be described more fully hereinafter with reference to the accompanying drawings, in which preferred embodiments of the invention are shown.

It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the principle that an inventor may properly define the meaning of the words or terms to best explain the invention.

As used herein, the singular forms “a”, “an” and “the” are intended to include the plural forms as well, unless the context clearly indicates otherwise. Terms indicating directions of apparatuses or elements (such as “front”, “back”, “up”, “down”, “top”, “bottom”, “left”, “right”, and “lateral”) are used to simplify description of the invention and do not represent nor mean that the apparatuses or elements have specific directions. Terms such as “first” and “second” used in this specification or the appended claims are not intended to represent or mean the relative importance or meaning.

The present invention may be embodied in different forms and should not be construed as limited to the embodiments set forth herein. Rather, these embodiments are provided as teaching examples of the invention. Therefore, it will be understood that the scope of the invention is intended to include various modifications and alternative arrangements within the capabilities of persons skilled in the art using presently known or future technologies and equivalents.

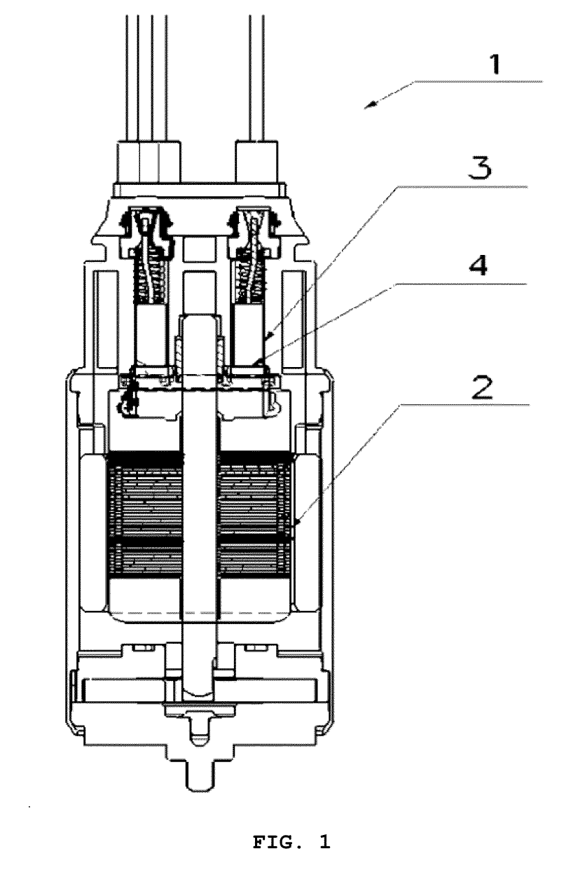

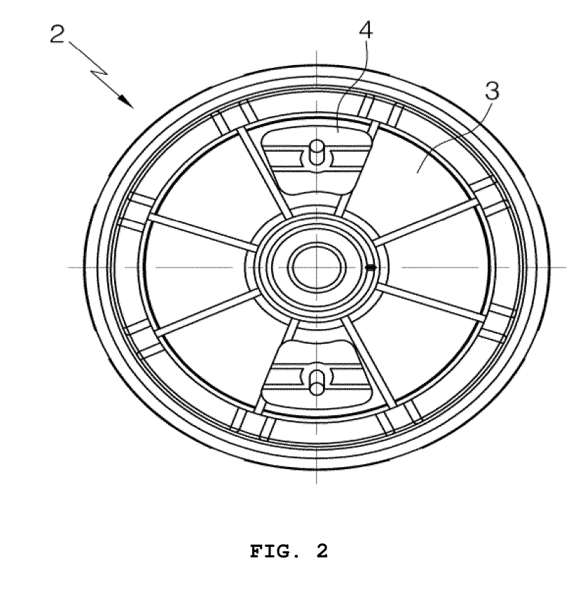

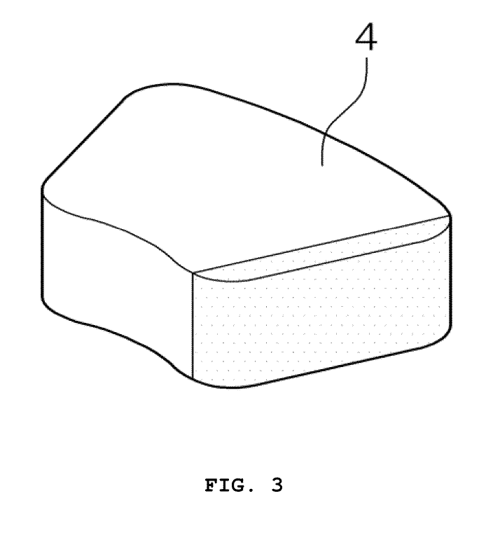

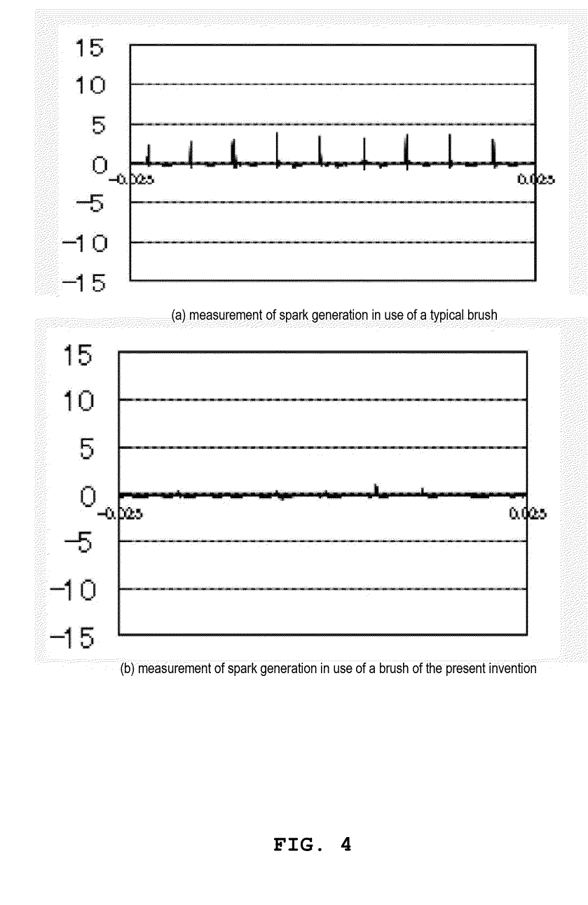

FIG. 1 is a sectional view of a fuel pump of a vehicle according to one embodiment of the present invention, FIG. 2 is a plan view of a brush and a commutator according to one embodiment of the present invention, FIG. 3 is a perspective view of a brush according to one embodiment of the present invention, and FIG. 4 is graphical views showing spark amounts measured in a brush of the present invention and a typical brush.

As illustrated in FIGS. 1 to 4, a brush 4 of a fuel pump for a vehicle according to the present invention is located in contact with the top surface of a commutator 3 of an armature 2 in a fuel pump 1 for a vehicle. The armature 2 is configured in such way that a plurality of the commutators 3 are attached to the outer circumference of the core forcibly-pressurized fit into the outer circumference of a rotation shaft, and a cover is provided on the outer circumference of the commutators 3. The structure of the armature 2 was briefly described as such, but the detailed description of the structure and the function thereof is omitted here because the armature 2 is widely and typically used.

As illustrated in FIGS. 1 to 3, the brush 4 is configured to contact with the top surface of the commutator 3 and more than one brush 4 are provided. Two brushes 4 are provided in the present invention, and come to slide in contact with the segments of the commutator 3, and not in contact with the commutator 3 when the commutator 3 is rotated, and contact and non-contact are successively repeated. The brush 4 is fan-shaped in plan view, and can contact with the commutator 3 for long when the commutator 3 is rotated.

As illustrated in FIG. 2, the commutator 3 is formed along the outer circumference of the core of a rotation shaft, and the commutator 3 is divided into a plurality of segments and attached to the outer circumference of the core. The commutators 3 are distanced from each other with a predetermined length. Thereby, the brush 4 located to the top surface of the commutator 3 contacts with the commutator 3 when it is rotated, and then does not contact with the commutator 3 at the distanced space between the segments of the commutators 3, and then contacts again.

In the typical armature, sparks are generated when the brush 4 is detached from the commutator 3, and thereby a problem of abrasion of the commutator 3 and the brush 4 was raised. Therefore, the present invention solves the problem by using high resistance material at the detached portion only of the brush 4 and also comes to minimize the problem of efficiency decrease.

The brush 4 of the present invention is formed of a high resistance material at the detached portion in order to suppress sparks generation when the brush 4 is detached from the commutator 3 at the slots of the commutators 3 formed with a plurality of segment commutators 3, and the rest portion of the brush 4 is formed of a material of lower resistance than the high resistance material.

The brush 4 is formed of a carbon material and the carbon material is divided into high resistance and low resistance according to carbon components.

While the invention was described above with reference to the finite embodiments and drawings, the invention is not limited to the embodiments but can be modified and changed in various forms by those skilled in the art without departing from the technical concept of the invention and the equivalents of the appended claims.

What is claimed is:

1. A structure of a brush of a fuel pump for a vehicle configured such that a plurality of brushes 4 are in contact with commutators 3 divided into a plurality of segments in an armature 2 of a fuel pump 1 for a vehicle, the brush 4 being formed of two kinds of materials to suppress the spark generation caused when the brush 4 is detached at the slot of the commutator 3 at the rotation of the armature 2.

2. The structure of a brush of a fuel pump for a vehicle according to claim 1, wherein a side portion of the brush 4 detached at the slot of the commutator 3 is formed of a high resistance material, and the rest portion of the brush 4 is formed of a lower resistance material than the high resistance material.

3. The structure of a brush of a fuel pump for a vehicle according to claim 2, wherein the brush 4 is formed of carbon based material, which is distinguished into high resistance and low resistance depending on the component of the carbon.
